(19) United States
(12) Patent Application Publication
(10) Pub. No.: US 2023/0193519 A1
(43) Pub. Date: Jun. 22, 2023

(54) POLYMERS HAVING STAIN RESISTANCE AND ANTIMICROBIAL/ANTIVIRAL PROPERTIES

(71) Applicant: Ascend Performance Materials Operations LLC, Houston, TX (US)

(72) Inventors: Bart Campbell, Houston, TX (US); John G. Hancock, Houston, TX (US); Scott Osborn, Houston, TX (US); Wai-shing Yung, Houston, TX (US)

(73) Assignee: Ascend Performance Materials Operations LLC, Houston, TX (US)

(21) Appl. No.: 18/067,398

(22) Filed: Dec. 16, 2022

Related U.S. Application Data
(60) Provisional application No. 63/291,042, filed on Dec. 17, 2021.

(51) Int. Cl. D01F 6/90; D01F 1/10; C08G 69/26; C08K 3/08; C08K 3/30

(52) U.S. Cl. CPC D01F 6/90; D01F 1/103; C08G 69/26; C08K 3/08; C08K 3/30; C08K 2003/0893; C08K 2003/309; D10B 2331/02; D10B 2401/13; D10B 2503/042

(57) ABSTRACT

The present invention provides antimicrobial and/or antiviral properties for polymers and synthetic fibers that have stain resistant properties. The synthetic fiber comprises a polymer, such as a copolymer comprising from 85 to 99.5 percent by weight of a polyamide based on the total weight of the fiber and an aromatic sulfonate or a salt thereof present in a range from 0.5 to 10 percent by weight based on the total weight of the fiber, one or more metal compounds or ions thereof dispersed within the copolymer, and a phosphorus compound.

### CROSS REFERENCE TO RELATED APPLICATION

This application claims priority to U.S. Provisional Application No. 63/291,042, filed on Dec. 17, 2021, which is incorporated herein by reference

### FIELD

The present disclosure relates to synthetic fibers having stain resistance with durable antimicrobial/antiviral properties. In particular, the synthetic fibers have an effective amount of metal ions dispersed within a polymer, wherein the polymer is preferably a copolymer comprising a polyamide and an aromatic sulfonate or a salt thereof.

### BACKGROUND

Synthetic fibers are used in a variety of applications that include additives to modify physical properties to increase performance. One physical property that is desirable for fibers is stain resistance. Fibers, including several types of synthetic fibers, are susceptible to staining from acid dyes in foodstuff, drinks and many other components, for example. Stain resistance has been provided by topical treatments, spray solutions, or adding stain blocking additives to a thermoplastic resin. These methods prevent staining of the fibers and allow the acid dyes stains to be rinsed out.

While stain resistance is successful in preventing degradation to visual performance, the synthetic fibers may also be exposed to microbes during finishing or exposed to organic substances from the environment. Stain resistance alone is not effective in preventing microbial growth. Microbial growth on synthetic fibers presents detrimental effects that can limit use. Further, producers are seeking to develop synthetic fibers for a hygienic and active lifestyle to limit or prevent microbial growth and satisfy customer demands.

In hygiene sensitive areas, such as healthcare and hospitality industries, certain fibers must meet demanding sanitation standards. To comply with these sanitation standards, the fibers are subject to daily washing and, often times, bleaching. Thus, in many applications, repeated cycles of use, washing, or soaking are quite common. Unfortunately, conventional fibers have been found to deteriorate and lose antimicrobial properties during repeated uses and/or wash cycles.

Some synthetic fibers having antimicrobial components are also known in the art. For example, U.S. Pat. No. 4,701,518 discloses a process to impart antimicrobial activity to nylon by adding to the nylon-forming monomer(s), a zinc compound (e.g. zinc ammonium carbonate) and a phosphorus compound (e.g. benzene phosphinic acid). According to this disclosure, the antimicrobial compounds are added in amounts sufficient to form in situ a reaction product containing at least 300 ppm of zinc, based on the weight of nylon prepared.

As another example, US Publication No. 2020/0102673 discloses antimicrobial fibers that include antimicrobial nanoparticles dispersed substantially uniformly in a polymer matrix. Textiles and other materials can be formed from such fibers. The fibers are formed via a masterbatch process or in a process wherein the antimicrobial nanoparticles, polymeric component, and additive(s) are melt processed together directly. Devices can be at least partially formed from polymer materials that include antimicrobial nanoparticles dispersed substantially uniformly in a polymer matrix.

Although there has been development of antimicrobial fibers, this development has occurred without stain resistance. Therefore, what is a needed are synthetic fibers that can achieve robust, durable, and/or washable antimicrobial/antiviral protection without sacrificing resistance to staining that can lead to damage, including discoloration or yellowing.

### SUMMARY

In some cases, the present disclosure provides a copolymer comprising a polyamide polymer present in a range from 85 to 99.5 percent by weight based on the total weight of the copolymer, an aromatic sulfonate or a salt thereof present in a range from 0.5 to 10 percent by weight based on the total weight of the copolymer, one or more metal compounds or ions thereof dispersed within the polyamide, and a phosphorus compound present in a range of less than 0.03 percent by weight based on the total weight of the copolymer. In one embodiment, the aromatic sulfonate salt may be a lithium, sodium, or potassium salt of 5-sulfoisophthalic acid. The copolymer may be formed into synthetic fibers.

In some cases, the present disclosure provides a copolymer comprising a polyamide present in a range from 85 to 99.5 percent by weight based on the total weight of the copolymer, a zinc salt of aromatic sulfonate present in a range from 0.5 to 10 percent by weight based on the total weight of the copolymer, and a phosphorus compound present in a range of less than 0.03 percent by weight based on the total weight of the copolymer. The zinc salt of aromatic sulfonate may provide more than 75% of the zinc present in the copolymer, and more preferably more than 90% of the zinc.

In some cases, the present disclosure provides a synthetic fiber comprising a copolymer comprising from 85 to 99.5 percent by weight of a polyamide based on the total weight of the fiber and an aromatic sulfonate or a salt thereof present in a range from 0.5 to 10 percent by weight based on the total weight of the fiber, one or more metal compounds or ions thereof dispersed within the copolymer, and a phosphorus compound present in an amount of less than 0.03 percent by weight based on the total weight of the fiber. In one embodiment the fibers exhibit a) a Staphylococcus aureus log reduction greater than 2.0 as tested in accordance with ISO 20743-13 and/or b) an Klebsiella pneumonia log reduction greater than 2.0 as tested in accordance with ISO 20743-13.

In some cases, the present disclosure provides a synthetic fiber comprising a copolymer comprising from 85 to 99.5 percent by weight of polyamide 6 or polyamide 6,6 based on the total weight of the fiber and an aromatic sulfonate salt comprising the lithium, sodium, or potassium salt of 5-sulfoisophthalic acid, present in an amount ranging from 0.5 to 10 percent by weight based on the total weight of the fiber, one or more metal compounds or ions thereof dispersed within the copolymer, and a phosphorus compound present in an amount of less than 0.03 percent by weight based on the total weight of the fiber. In one embodiment the fibers exhibit a) a Staphylococcus aureus log reduction greater than 2.0 as tested in accordance with ISO 20743-13 and/or b) an Klebsiella pneumonia log reduction greater than 2.0 as tested in accordance with ISO 20743-13.

In some cases, the present disclosure provides a synthetic fiber comprising a polyester polymer or polyolefin polymer having a stain resistance that is greater than that displayed by a polyamide without an aromatic sulfonate or a salt thereof, one or more metal compounds or ions thereof dispersed within the polyester or polyolefin polymer, and a phosphorus compound present in an amount of less than 0.03 percent by weight based on the total weight of the fiber, wherein fibers exhibit a) a Staphylococcus aureus log reduction greater than 2.0 as tested in accordance with ISO 20743-13 and b) an Klebsiella pneumonia log reduction greater than 2.0 as tested in accordance with ISO 20743-13. Preferably, polyethylene terephthalate, polytrimethylene terephthalate, polyethylene, polypropylene or combinations thereof may be used as the polymer.

### DETAILED DESCRIPTION

According to the embodiments disclosed herein, the present disclosure provides an improvement in antimicrobial and/or antiviral (AM/AV) properties for fibers that have stain resistant properties. In one embodiment, an unwanted acid dye in an organic material may be the source of the stain. The organic material containing the unwanted acid dye may be susceptible to contamination from microbes. Without the improvement disclosed herein, the microbes may further spread. Although the source of the microbes may be the source causing the stain, fibers may also contact microbes from non-staining sources. In addition, the AM/AV properties are retained and remain effective after cleaning of the fibers following contact with an unwanted acid dye. The antimicrobial and/or antiviral agents are not extracted out when removing the unwanted acid dye.

For purposes of the present disclosure, the polymer has stain resistance properties. This includes polymers such as polyester or polyolefin having a stain resistance that is greater than a polyamide without an aromatic sulfonate or a salt thereof. In addition, this includes a copolymer of a polyamide with an aromatic sulfonate or a salt thereof. The polymers may be formed into synthetic fibers.

### Copolymer of Polyamide

The synthetic fibers are made from a copolymer comprising a polyamide, which, in some embodiments, is suitable for producing textiles, molded products, films, and fabrics. In one embodiment, the copolymer comprises a polyamide in an amount ranging from 85 wt. % to 99.5 wt. %, e.g., from 87 wt. % to 99.1 wt. %, from 88 wt. % to 99 wt. %, from 90 wt. % to 99 wt. %, from 90 wt. % to 97.5 wt. %, from 92 wt. % to 97.5 wt. %, or from 93 wt. % to 97 wt. %. In terms of upper limits, the synthetic fibers may comprise less than or equal to 99.5 wt. % of the polyamide, e.g., less than 99.1 wt. %, less than 99 wt. %, less than 97.5 wt. %, or less than 97 wt. %. In terms of lower limits, the copolymer may comprise greater than 85 wt. % of the polyamide, e.g., greater than 87 wt. %, greater than 88 wt. %, greater than 90 wt. %, or greater than 92 wt. %.

Polyamides include those synthesized from monomers such as lactams, alpha-omega amino acids, diacids, and diamines. In one embodiment, the polyamide is the reaction product of one or more diacids, wherein more than 80% of the diacids are aliphatic diacid monomers, e.g., more than 85%, more than 90%, more than 95%, more than 97%, or preferably more than 99%, and one or more diamines, wherein more than 80% of the diamines are aliphatic diamine monomers, e.g., more than 85%, more than 90%, more than 95%, more than 97%, or preferably more than 99%.

In general the polyamides are synthesized from diacids and diamines having a limited amount of residual or unreacted monomers being generally less than 5 wt. %, and within a range from 0.005 wt. % to 5 wt. %, e.g., from 0.01 wt. % to 5 wt. %, from 0.01 wt. % to 4.5 wt. %, from 0.01 wt. % to 4 wt. %, from 0.01 wt. % to 3.5 wt. %, from 0.01 wt. % to 3 wt. %, from 0.01 wt. % to 2.5 wt. %, from 0.01 wt. % to 2 wt. %, from 0.01 wt. % to 1.5 wt. %, or from 0.01 wt. % to 1 wt. %. Although the polyamides may have lower residual monomers, it is generally preferable to control the processing to avoid higher amounts of residual monomer that limit production.

In one embodiment, the diacids may include one or more of the following monomers: adipic acid, isophthalic acid, terephthalic acid, naphthalene dicarboxylic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecane acid, 1,16-hexadecanedioic acid, 1,17-heptadecanedioic acid, 1,18-octadecanedioic acid, cyclohexanedioic acid, or phenylindanedicarboxylic acid. Preferably adipic acid is used as a monomer. In one embodiment, the diamines may include one or more of the following monomers: ethylenediamine, butanediamine, pentanediamine, 1,6-hexanediamine, methylpentanediamine, 1,8-octanediamine, methyloctanediamine, 1,9-nonanediamine, 1,10-decanediamine, 1,11-undecanediamine, 1,12-dodecanediamine, trimethyl hexamethylenediamine, 1,4-cyclohexanediamine, bis-(4-amino-3-methyl-cyclohexyl)methane, bis-(4-amino-cyclohexyl)methane, isophoronediamine, 1,4-bis(aminomethyl)cyclohexane, m-xylylenediamine, p-xylylenediamine bis(aminocyclohexyl)propane and its alkyl derivatives, norbornanediamine and bis(aminomethyl)norbornane. Preferably 1,6-hexanediamine is used as a monomer.

In some cases, the copolymer may comprise a polyamide. Polyamides include, but are not limited to, poly(propiolactam) [PA 3], polycaprolactam [PA 6], polycapryllactam [PA 8], poly(hexamethylene adipamide) [PA 6,6], poly(tetramethylene adipamide) [PA 4,6], poly(decano-10-lactam) [PA 10], polyundecanolactam [PA 11], polylauryllactam [PA 12], poly(hexamethylene azelamide) [PA 6,9], poly(hexamethylene sebacamide) [PA 6,10], poly(hexamethylene dodecanediamide) [PA 6,12], poly(decamethylene sebacamide) [PA 10,10], poly(hexamethylene isophthalamide) [PA 6I], poly(hexamethylene teraphthalamide) [PA 6T], poly(nonanmethylene teraphthalamide) [PA 9T], and copolymers, blends, mixtures and/or other combinations thereof such as PA-6,6/6; PA-6,6/6,10; PA-6,6/6,12; PA-6,6/6T; PA-6T/6I; PA-6T/6I/6; PA-6T/6; PA-6T/6I/66 and copolymers, blends, mixtures and/or other combinations thereof. Other polyamides may include PA-4T/4I; PA-4T/6I; PA-5T/5I; PA-6T/MPMDT (where MPMDT is polyamide based on a mixture of hexamethylene diamine and 2-methylpentamethylene diamine as the diamine component and terephthalic acid as the diacid component); PA-6T/66; PA-6T/610; PA-10T/612; PA-10T/106; PA-6T/612; PA-6T/10T; PA-6T/10I; PA-9T; PA-10T; PA-12T; PA-10T/10I; PA-10T/12; PA-10T/11; PA-6T/9T; PA-6T/12T; PA-6T/10T/6I; PA-6T/6I/6; PA-6T/61/12; and copolymers, blends, mixtures and/or other combinations thereof.

The copolymer may, in some embodiments, comprise a combination of polyamides. By combining various polyamides, the copolymer may be able to incorporate the desirable properties, e.g., mechanical properties, of each constituent polyamides. For example, in some embodiments, the copolymer comprises a combination of PA-6, PA-6,6, and PA-6,6/6T. In these embodiments, the copolymer may comprise from 1 wt. % to 99 wt. % PA-6, from 30 wt. % to 99 wt. % PA-6,6, and from 1 wt. % to 99 wt. % PA-6,6/6T. In some embodiments, the copolymer comprises one or more of PA-6, PA-6,6, and PA-6,6/6T. In some aspects, the copolymer comprises 6 wt. % of PA-6 and 94 wt. % of PA-6,6. In some aspects, the copolymer comprises copolymers or blends of any of the polyamides mentioned herein.

The copolymer may also comprise polyamides produced through the ring-opening polymerization or polycondensation, including the copolymerization and/or copolycondensation, of lactams. Without being bound by theory, these polyamides may include, for example, those produced from propiolactam, butyrolactam, valerolactam, and caprolactam. For example, in some embodiments, the polyamide is a polymer derived from the polymerization of caprolactam. In those embodiments, the polymer comprises at least 10 wt. % caprolactam, e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, or at least 60 wt. %. In some embodiments, the polymer includes from 10 wt. % to 60 wt. % of caprolactam, e.g., from 15 wt. % to 55 wt. %, from 20 wt. % to 50 wt. %, from 25 wt. % to 45 wt. %, or from 30 wt. % to 40 wt. %. In some embodiments, the polymer comprises less than 60 wt. % caprolactam, e.g., less than 55 wt. %, less than 50 wt. %, less than 45 wt. %, less than 40 wt. %, less than 35 wt. %, less than 30 wt. %, less than 25 wt. %, less than 20 wt. %, or less than 15 wt. %. Furthermore, the copolymer may comprise the polyamides produced through the copolymerization of a lactam with a nylon, for example, the product of the copolymerization of caprolactam with PA-6,6.

Polyamide salts are formed by reaction of diamines with dicarboxylic acids with the resulting salt providing the monomer. In some aspects, the polyamide may be formed by polymerization in which an aqueous solution of at least one diamine-carboxylic acid salt is heated to remove water and effect polymerization to form a polyamide. In some embodiments, a preferred polyamide-forming salt is hexamethylenediamine adipate (nylon 6,6 salt) formed by the reaction of equimolar amounts of hexamethylenediamine and adipic acid. As described further herein, in one embodiment, the aqueous solution may include effective amounts of one or more metal compounds or ions thereof (zinc, copper, or silver) so that the metal compounds or ions thereof are dispersed within the polyamide and/or the copolymer.

The inventors have found that the content of amine end groups (AEG) may have a surprising effect on the performance of the synthetic fiber. As one example, the AEGs have been found to improve the ability to dye fibers and/or fabrics. The polyamide may have an AEG content ranging from 1 μeq/gram to 105 μeq/gram, e.g., from 1 μeq/gram to 75 μeq/gram, from 1 μeq/gram to 55 μeq/gram, from 5 μeq/gram to 50 μeq/gram, or from 15 μeq/gram to 40 μeq/gram. In terms of upper limits, the polyamide may have an AEG content less than or equal to 105 μeq/gram, e.g., less than or equal to 100 μeq/gram, less than or equal to 90 μeq/gram, less than or equal to 75 μeq/gram, less than or equal to 55 μeq/gram, less than or equal to 50 μeq/gram, less than or equal to 45 μeq/gram, less than or equal to 40 μeq/gram, less than or equal to 35 μeq/gram, less than or equal to 30 μeq/gram, or less than or equal to 25 μeq/gram. In terms of lower limits, the polyamide may have an AEG content greater than 1 μeq/gram, e.g., greater than 5 μeq/gram, greater than 10 μeq/gram, greater than 15 μeq/gram, greater than 20 μeq/gram, greater than 25 μeq/gram, greater than 35 μeq/gram, greater than 40 μeq/gram, or greater than 50 μeq/gram.

### Aromatic Sulfonate or Salt Thereof

In one embodiment, the copolymer comprises a polyamide and an aromatic sulfonate or salt thereof. The copolymer may comprise an aromatic sulfonate or salt thereof in an amount ranging from 0.5 wt. % to 10 wt. %, e.g., from 0.5 wt. % to 9.5 wt. %, from 1 wt. % to 9.5 wt. %, from 1 wt. % to 9 wt. % from 1 wt. % to 7.5 wt. %, from 1 wt. % to 5 wt. %, or from 1 wt. % to 3 wt. %. In terms of upper limits, the synthetic fibers may comprise less than or equal to 10 wt. % of the aromatic sulfonate or a salt thereof, e.g., less than 9.5 wt. %, less than 9 wt. %, less than 8 wt. %, or less than 7.5 wt. %. To provide sufficient stain resistance, the minimum amount of aromatic sulfonate or salt thereof should be greater than 0.5 wt. %, e.g., greater than 0.75 wt. %, greater than 1 wt. %, greater than 1.25 wt. %, or greater than 1.5 wt. %. The sulfur level provided by the aromatic sulfonate or salt thereof may be in an amount that is less than 15,000 ppm by weight, e.g., less than 14,500 ppm by weight, less than 12,000 ppm by weight, less than 11,000 ppm by weight, less than 10,000 ppm by weight, less than 9,000 ppm by weight, less than 8,000 ppm by weight, less than 7,000 ppm by weight, or less than 6,000 ppm by weight. In terms of ranges, the sulfur level may be from 10 to 15,000 ppm by weight, e.g., from 10 to 14,500 ppm by weight, from 10 to 12,000 ppm by weight, from 100 to 10,000 ppm by weight, from 250 to 9,000 ppm by weight, from 250 to 8,000 ppm by weight, from 250 to 7,000 ppm by weight, or from 250 to 6,000 ppm by weight, or from 2,000 to 4,000 ppm by weight.

The aromatic sulfonate may comprise isophthalic acid sulfonate, terephthalic acid sulfonate, dimethyl-5-sulfoisophthalate, 2,6-naphthalene dicarboxylic acid sulfonate, 3,4′-diphenyl ether dicarboxylic acid sulfonate, hexahydrophthalic acid sulfonate, 2,7-naphthalenedicarboxylic acid sulfonate, phthalic acid sulfonate, 4,4′-methylenebis(benzoic acid) sulfonate, or salts thereof. The aromatic sulfonate or a salt thereof may be lithium, sodium, or potassium salt of 5-sulfoisophthalic acid, and more particularly lithium salt of 5-sulfoisophthalic acid.

In one embodiment, the salt of the aromatic sulfonate is a zinc salt of the aromatic sulfonate, and in particular, zinc salts of 5-sulfoisophthalic acid, isophthalic acid sulfonate, terephthalic acid sulfonate, dimethyl-5-sulfoisophthalate, 2,6-naphthalene dicarboxylic acid sulfonate, 3,4′-diphenyl ether dicarboxylic acid sulfonate, hexahydrophthalic acid sulfonate, 2,7-naphthalenedicarboxylic acid sulfonate, phthalic acid sulfonate, or 4,4′-methylenebis(benzoic acid) sulfonate. The zinc salt may provide the antimicrobial/antiviral properties, and in one embodiment, provides more than 75% of the zinc, e.g., more than 80%, more than 85%, more than 90%, or more than 95%. Thus, an additional metal ion may not be required for such embodiments that use a zinc salt.

Staining may result from an unwanted acid dye from foodstuff, drinks, cosmetics, and many other components, for example, that contain natural or synthetic colorants. In one embodiment, the stain resistance is achieved by incorporating the aromatic sulfonate or salt thereof into the copolymer to prevent the acid dye binding sites (amine end groups or amide linkages) on the polyamide from interacting with the acid dyes. The polyamide may also provide stain resistance properties to neutralize the acid dyes, and these properties are enhanced by the incorporation of the aromatic sulfonate in the copolymers disclosed herein. As understood, stain resistance is the ability for the synthetic fiber to experience no or little damage and in particular damage from discoloration or yellowing.

The aromatic sulfonate may be combined with the polyamide in any suitable form such as powdered, pelletized, compacted, etc. The powder, granule, or pellet form of the polyamide may also comprise antimicrobial and/antiviral (AM/AV) compounds. In one embodiment, the aromatic sulfonate and the polyamide are preferably combined employing a melt extruder and, most preferably, a screw-type extruder, of a design suitable for dispersion and distribution of a solid in a thermoplastic melt. In one embodiment, the moisture content of the aromatic sulfonate and polyamide prior to being combined may be low to effectively form a copolymer, and in particular may be less than 200 ppm by weight of water, e.g., less than 175 ppm by weight of water, less than 150 ppm by weight of water, or less than 125 ppm by weight of water. In some embodiments, drying or conditioning may be used as necessary to achieve lower moisture levels.

In one embodiment, the copolymer may have a glass transition temperature (Tg), as measured by differential scanning calorimetry (DSC), from 50 to 200° C., e.g., from 60 to 190° C., or more preferably from 65 to 90° C. The melt temperature of the copolymer in accordance with the disclosure preferably is in the range from 100 to 260° C., e.g., from 205 to 245° C., or from 210 to 235° C. The copolymer may have a crystallization temperature in the range from 130 to 200° C., preferably in the range from 140 to 200° C.

In some embodiments, the copolymer (and the fibers/fabrics produced therefrom) advantageously comprise little or no content of processing aids such as surfactants and/or coupling agents. In some cases, the copolymer comprises less than 100 wppm surfactant and/or coupling agent, e.g., less than 50 wppm, less than less than 20 wppm, less than 10 wppm, or less than 5 wppm. In terms of ranges, the copolymer may comprise from 1 wppb to 100 wppm, e.g., from 1 wppb to 20 wppm, from 1 wppb to 10 wppm, or from 1 wppb to 5 wppm. The disclosed copolymers may not employ any surfactant and/or coupling agent at all. There can be no surfactant and/or coupling agent present after processing, which is not the case for conventional formulations that do employ surfactant and/or coupling agents as necessary components. Even though some of these components may burn off during processing, some surfactant and/or coupling agent will remain in the resultant fibers.

Common surfactants include anionic surfactants, cationic surfactants, and/or nonionic surfactants. Specific examples are stearic acid, sodium dodecyl sulfonate surfactants, quaternary ammonium surfactants, amino acid surfactants, betaine surfactants, fatty acid glyceride ester surfactants, fatty acid sorbitan surfactants, lecithin surfactants, and/or Tween™ series surfactants (e.g., polyethoxylated sorbitan ester surfactants, nonionic polyoxyethylene surfactants, etc.).

In some embodiments, the stain resistance of the copolymer according to standard AATCC Test Method 175-2003 is at least greater than 3, e.g., at least greater than 4, at least greater than 5, at least greater than 6, or up to 10 which is no residual stain. Having such stain resistance properties ensures that the synthetic fibers are easier to clean and require less effort to remove the stain. This beneficially may reduce the time and materials needed for cleaning, which has an improved reduction in energy consumed.

### Polyesters and Polyolefins

In one embodiment, the polymer may have stain resistance properties, in particular, having a stain resistance that is greater than a polyamide without an aromatic sulfonate or salt thereof. Such polymers may include polyester polymers (e.g. polytrimethylene terephthalate, polyethylene terephthalate, polybutylene terephthalate or combinations thereof) or polyolefin polymers (polyethylene, polypropylene, or combinations thereof). These polymers may be hydrophobic and contain low levels of sulfur. Thus, in one embodiment, the polymer may contain less than 0.01 wt. % of an aromatic sulfonate or salt thereof, e.g., less than 0.001 wt. % of an aromatic sulfonate or salt thereof, or less than 0.005 wt. % of an aromatic sulfonate or salt thereof. These polymers may provide additional benefits when the synthetic fibers are used for carpets, such as fire resistance and aesthetic appeal.

Polyester and polypropylene fibers typically do not require a stain blocker treatment owing to the inherent stain resistance. This may be due to the lack of amine end groups that function as acid dye binding sites. In one embodiment, a topical stain blocking agent may be used with the polyester and polypropylene fibers.

For purposes of the present disclosure PTT (polytrimethylene terephthalate) includes both homopolymers and copolymers containing at least 70 mole % trimethylene terephthalate monomers, e.g., at least 85 mole %, at least 90 mole %, at least 95 mole %, at least 98 mole %, and most preferably about 100 mole %. PTT may be produced by the acid-catalyzed polycondensation of 1,3-propanediol and terephthalic acid/diester, with optional minor amounts of other monomers.

### Additives

Each type of polymer disclosed herein, including the polyesters, polyolefins, and copolymers, may further comprise other additives, to be used to confer additional benefits to fibers depending on the application and end use. Examples of suitable additives include oils (such as finishing oils, e.g., silicone oils), waxes, solvents (including formic acid as described herein), lubricants (e.g., paraffin oils, amide waxes, and stearates), stabilizers (e.g., photostabilizers, UV stabilizers, optical brightening agents, etc.), delusterants, antioxidants, solubilizers, agents which counteract fragrances or odors, complexing agents, compatibilizing agents, colorants including pigments and dyes, promoters enhancing oxygen barrier properties, or combinations thereof. The additives may be present in a total amount of up to 10 wt. % based on the total weight of the fiber, e.g., up to 7.5 wt. %, up to 6 wt. %, up to 5 wt. %, up to 4.5 wt. %, up to 4 wt. %, up to 2 wt. %, or up to 1 wt. %. In terms of lower limits, the additives may be present in an amount of at least 0.01 wt. % based on the total weight of the fiber, e.g., at least 0.05 wt. %, at least 0.1 wt. %, at least 0.25 wt. %, or at least 0.5 wt. %. In terms of ranges, the additives may be present in an amount from 0.01 to 10 wt. %, e.g., from 0.05 to 10 wt. %, from 0.1 to 5 wt. %, from 0.25 to 5 wt. %, from 0.5 to 5 wt. %, from 0.5 to 4.5 wt. %, or from 0.5 to 2 wt. %.

Antioxidants suitable for use in conjunction with the copolymer described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, delta-tocopherol), tocotrienols, ubiquinol, gallic acids, melatonin, secondary aromatic amines, benzofuranones, hindered phenols, polyphenols, hindered amines, organophosphorus compounds, thioesters, benzoates, lactones, hydroxylamines, and the like, and any combination thereof. In some embodiments, the antioxidant may be selected from the group consisting of stearyl 3-(3,5-di-tert-butyl-4-hydroxyphenyl) propionate, bis(2,4-dicumylphenyl)pentaerythritol diphosphite, tris(2,4-di-tert-butylphenyl)phosphite, bisphenol A propoxylate diglycidyl ether, 9,10-dihydroxy-9-oxa-10-phosphaphenanthrene-10-oxide, and mixtures thereof.

Colorants, pigments, and dyes suitable for use in conjunction with the copolymer described herein may, in some embodiments, include, but are not limited to, plant dyes, vegetable dyes, titanium dioxide (which may also act as a delusterant), magnesium dioxide, barium sulfate, carbon black, charcoal, silicon dioxide, tartrazine, E102, phthalocyanine blue, phthalocyanine green, quinacridones, perylene tetracarboxylic acid di-imides, dioxazines, perinones, diazo pigments, anthraquinone pigments, metal powders, iron oxide, ultramarine, nickel titanate, benzimidazolone orange GL, solvent orange 60, orange dyes, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL Brilliant Yellow K-6G liquid, CARTASOL Yellow K-4GL liquid, CARTASOL Yellow K-GL liquid, CARTASOL Orange K-3GL liquid, CARTASOL Scarlet K-2GL liquid, CARTASOL Red K-3BN liquid, CARTASOL Blue K-5R liquid, CARTASOL Blue K-RL liquid, CARTASOL Turquoise K-RL liquid/granules, CARTASOL Brown K-BL liquid), FASTUSOL® dyes (an auxochrome, available from BASF) (e.g., Yellow 3GL, Fastusol C Blue 74L), and the like, any derivative thereof, and any combination thereof. In some embodiments, solvent dyes may be employed.

Examples of UV light absorbers or optical brightening agents are 2,2′-(1,2-ethenediyldi-4,1 phenylene)bisbenzoxazole, available commercially by Eastman Chemical Company under the tradename Eastobrite® OB-1, and 2,2′-(2,5-thiophenediyl)bis(5-tert-butylbenzoxazole, available commercially by Mayzo, Inc. under the tradename Benetex® OB.

### Antimicrobial/Antiviral Compounds

The polymers for making synthetic fibers comprises at least one compound that has an efficacy for reducing or eliminating microbials, bacteria, viruses, fungi, or parasites. In general, such compounds are referred to as antimicrobial/antiviral (AM/AV) compounds for purposes of the present disclosure. Preferably the AM/AV compound is effective for reducing microbials, such as but not limited to a Streptococcus bacterium (e.g., Streptococcus pneumonia, Streptococcus pyogenes), a Staphylococcus bacterium (e.g., Staphylococcus aureus (S. aureus), Methicillin-resistant Staphylococcus aureus (MRSA)), a Peptostreptococcus bacteria (e.g., Peptostreptococcus anaerobius, Peptostreptococcus asaccharolyticus), a Mycobacterium bacterium, (e.g., Mycobacterium tuberculosis), a Mycoplasma bacteria (e.g., Mycoplasma adleri, Mycoplasma agalactiae, Mycoplasma agassizii, Mycoplasma amphoriforme, Mycoplasma fermentans, Mycoplasma genitalium, Mycoplasma haemofelis, Mycoplasma hominis, Mycoplasma hyopneumoniae, Mycoplasma hyorhinis, Mycoplasma pneumoniae), Escherichia coli and/or Klebsiella pneumoniae.

In some embodiments, the composition, structure, and/or fibers demonstrate improved antimicrobial performance, e.g., after 24 hours. For example, the composition, structure, and/or fibers may demonstrate Staphylococcus aureus reduction (inhibition of growth) of at least 90%, as measured by ISO 20743-13, e.g., at least 95%, at least 99%, at least 99.98%, at least 99.99%, at least 99.997%, at least 99.999%, or at least 99.9999%.

In some embodiments, the synthetic fibers demonstrate improved antimicrobial performance. For example, the composition, synthetic fiber may demonstrate Klebsiella pneumoniae reduction (inhibition of growth) of at least 90%, as measured by ISO 20743-13, e.g., at least 95%, at least 99%, at least 99.98%, at least 99.99%, at least 99.999%, at least 99.9998%, or at least 99.9999%. In terms of log reduction (Staphylococcus aureus), the synthetic fiber may demonstrate a log reduction of greater than 2.0, e.g., greater than 3.0, greater than 3.5, greater than 4.0, greater than 4.375, greater than 4.5, or greater than 5.0.

In terms of log reduction (Klebsiella pneumoniae), the synthetic fiber may demonstrate a log reduction of greater than 3.0, e.g., greater than 3.75, greater than 4.0, greater than 4.25, greater than 4.5, greater than 4.75, greater than 5.0, greater than 5.5, or greater than 6.0.

In one embodiment, the synthetic fiber may comprise one or more metal compounds or ions thereof. In particular, the metals ions may be used in an effective amount to deactivate the microbes. An effective amount as used herein refers to an amount of the one or more metal compounds or ions thereof that, when incorporated with the copolymer, provides an antimicrobial and/antiviral activity to reduce, prevent growth, or eliminate (collectively referred to as deactivating) the microbes exposed to the synthetic fiber or article made from the fiber. The present inventors have found that the concentration of the one or more metal compounds or ions thereof may be greater than or equal to 200 ppm by weight, based on the total weight of the fiber, e.g., greater than or equal to 250 ppm, greater than or equal to 300 ppm, greater than or equal to 350 ppm, greater than or equal to 400 ppm, or greater than or equal to 450 ppm, without having a significant stain resistance loss. Lower amounts of metal ions tend to have limited efficacy to deactivate microbes. Although higher amounts of metals ions may be used, it is generally preferred to use an effective amount with the copolymers described herein. Thus, the ranges of metal ions may be from 200 ppm to 1,000 ppm by weight, based on the total weight of the fiber, including subranges therein, such as preferred ranges from 250 ppm to 950 ppm, from 250 ppm to 800 ppm, from 300 ppm to 550 ppm, or from 300 to 500 ppm. In some aspects, metal ions are dispersed in the polymer or copolymer.

The metal ions may be incorporated into the copolymer during polymerization using suitable compounds, such as oxides, carbonates, stearates, pyrithiones, or adipates. This may achieve a wide distribution of the metal ions so that the synthetic fiber maintains its antimicrobial/antiviral characteristics. In some embodiments, the metal ions are distributed in an uniform manner. Once incorporated, the metal compounds are readily ionized and remain in the ionized form. Accordingly, the concentration of the one or more metal ions exceeds the concentration of one or more metal compounds.

As described above, in one embodiment, the metal ions are incorporated from a zinc salt of an aromatic sulfonate. Thus, additional compounds to deliver the metal ions are not necessary but may be included. A sufficient amount of the zinc salt of an aromatic sulfonate is used to achieve both stain resistance and antimicrobial/antiviral activity.

In some embodiments, zinc ions (Zn²⁺) are preferred metal ions. The zinc ions may be provided by one or more of zinc oxide, zinc ammonium adipate, zinc acetate, zinc ammonium carbonate, zinc stearate, zinc phenyl phosphinic acid, zinc pyrithione, or combinations thereof. In some aspects, the zinc is provided in the form of zinc oxide. In some aspects, the zinc is not provided via zinc phenyl phosphinate and/or zinc phenyl phosphonate. In some aspects, the zinc compound is ionized and the zinc ion is dispersed in the copolymer. The concentration of the zinc ions may be greater than or equal to 200 wppm, e.g., greater than or equal to 250 wppm, greater than or equal to 300 wppm, greater than or equal to 350 wppm, greater than or equal to 400 wppm, or greater than or equal to 450 wppm. Particularly suitable ranges of zinc ions may be from 200 wppm to 1,000 wppm, including subranges therein, such as preferred ranges from 250 wppm to 950 wppm, from 250 wppm to 800 wppm, from 300 wppm to 550 wppm, or from 300 wppm to 500 wppm.

In some cases, the use of zinc provides for processing and/or end use benefits. Other antimicrobial/antiviral agents, e.g., copper or silver, may be used, but these often include adverse effects (e.g., on the relative viscosity of the polymer composition, toxicity, and health or environmental risk). In some situations, the zinc compound and zinc ion do not have adverse effects on the stain resistance of the synthetic fiber and/or relative viscosity of the copolymer. Also, the zinc does not present toxicity issues, unlike other antimicrobial/antiviral agents. The use of zinc in some applications may provide for health advantages, such as immune system support. In addition, as noted herein, the use of zinc ions provides for the reduction or elimination of leaching into other media and/or into the environment. Notably, this both prevents the risks associated with introducing zinc into the environment and allows the copolymer to be reused-zinc provides surprising “green” advantages over other types of antimicrobial/antiviral agents.

As noted above, copper ions (provided via a copper compound) may be incorporated into the copolymer. The copper ions may be used independently or in combination with zinc ions. In some cases, the copper compound may improve, e.g., enhance, the antimicrobial/antiviral properties of the copolymer and the overall synthetic fiber.

When used independently, the concentration of the copper ions may be greater than or equal to 200 wppm, e.g., greater than or equal to 250 wppm, greater than or equal to 300 wppm, greater than or equal to 350 wppm, greater than or equal to 400 wppm, or greater than or equal to 450 wppm. Particularly suitable ranges of copper ions may be from 200 wppm to 1,000 wppm, including subranges therein, such as preferred ranges from 250 to 950 wppm, from 250 to 800 wppm or 300 to 550 wppm, or from 300 to 500 wppm.

When copper ions are used as a promoter with zinc ions, the concentration of copper ions may be lower. In one embodiment, the molar ratio of the copper ions to the zinc ions is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the copper ions to the zinc ions in the copolymer may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1 from 0.5:1 to 4:1, or from 0.5:1 to 3:1. In terms of upper limits, the molar ratio of zinc ions to copper ions in the copolymer may be less than 15:1, e.g., less than 10:1, less than 9:1, less than 8:1, less than 7:1, less than 6:1, less than 5:1, less than 4:1, or less than 3:1. In some cases, copper ion is dispersed within the copolymer along with zinc ion.

In some embodiments, copper ions as a promoter may be present in amounts greater than or equal to 5 wppm when used with zinc ions in an amount greater than or equal to 200 wppm. More preferably, copper ions as a promoter with zinc ions may be present in amounts greater than or equal to 10 wppm, greater than or equal to 15 wppm, greater than or equal to 20 wppm, greater than or equal to 25 wppm, greater than or equal to 50 wppm, or greater than or equal to 100 wppm. In one embodiment, the copolymer comprises copper ions as a promoter in an amount ranging from 5 wppm to 800 wppm, e.g., from 10 wppm to 750 wppm, from 10 wppm to 600 wppm, from 10 wppm to 500 wppm, from 10 wppm to 400 wppm, from 10 wppm to 300 wppm, from 10 wppm to 250 wppm, from 10 wppm to 200 wppm, or from 10 wppm to 150 wppm.

The copper compound is not particularly limited. Suitable copper compounds include copper iodide, copper bromide, copper chloride, copper fluoride, copper oxide, copper stearate, copper ammonium adipate, copper acetate, copper pyrithione, or combinations thereof. The copper compound may comprise copper oxide, copper ammonium adipate, copper acetate, copper ammonium carbonate, copper stearate, copper phenyl phosphinic acid, copper pyrithione, or combinations thereof. In some embodiments, the copper compound comprises copper oxide, copper ammonium adipate, copper acetate, copper pyrithione, or combinations thereof. In some embodiments, the copper compound comprises copper oxide, copper stearate, copper ammonium adipate, or combinations thereof. In some aspects, the copper is provided in the form of copper oxide. In some aspects, the copper is not provided via copper phenyl phosphinate and/or copper phenyl phosphonate.

As noted above, silver ions (provided via a silver compound) may be incorporated into the copolymer. The silver ions may be used independently or in combination with zinc ions and/or copper ions. In some cases, the silver compound may improve, e.g., enhance the antimicrobial/antiviral properties of the synthetic fiber.

When used independently, the concentration of the silver ions may be greater than or equal to 200 wppm, e.g., greater than or equal to 250 wppm, greater than or equal to 300 wppm, greater than or equal to 350 wppm, greater than or equal to 400 wppm, or greater than or equal to 450 wppm. Particularly suitable ranges of silver ions may be from 200 wppm to 1,000 wppm, including subranges therein, such as preferred ranges from 250 wppm to 950 wppm, from 250 wppm to 800 wppm, from 300 wppm to 550 wppm, or from 300 wppm to 500 wppm.

When silver ions are used as a promoter with zinc and/or copper ions, the concentration of silver ions may be lower. In one embodiment, the molar ratio of the silver ions to the zinc ions and/or copper ions is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the silver ions to the zinc ions and/or copper ions in the copolymer may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1, from 0.5:1 to 4:1, or from 0.5:1 to 3:1. In terms of upper limits, the molar ratio of zinc ions and/or copper ions to silver ions in the copolymer may be less than 15:1, e.g., less than 10:1, less than 9:1, less than 8:1, less than 7:1, less than 6:1, less than 5:1, less than 4:1, or less than 3:1. In some cases, silver ion may be bound to copolymer along with zinc ions and/or copper ions.

In some embodiments, silver ions as a promoter may be present in amounts greater than or equal to 5 wppm when used with zinc ions in an amount greater than or equal to 200 wppm. More preferably, silver ions as a promoter with zinc ions may be present in amounts greater than or equal to 10 wppm, greater than or equal to 15 wppm, greater than or equal to 20 wppm, greater than or equal to 25 wppm, greater than or equal to 50 wppm, or greater than or equal to 100 wppm. In one embodiment, the copolymer comprises silver ions as a promoter in an amount ranging from 5 wppm to 800 wppm, e.g., from 10 wppm to 750 wppm, from 10 wppm to 600 wppm, from 10 wppm to 500 wppm, from 10 wppm to 400 wppm, from 10 wppm to 300 wppm, from 10 wppm to 250 wppm, from 10 wppm to 200 wppm, or from 10 wppm to 150 wppm.

The silver compound is not particularly limited. Suitable silver compounds include silver iodide, silver bromide, silver chloride, silver fluoride, silver oxide, silver stearate, silver ammonium adipate, silver acetate, silver pyrithione, or combinations thereof. The silver compound may comprise silver oxide, silver ammonium adipate, silver acetate, silver ammonium carbonate, silver stearate, silver phenyl phosphinic acid, silver pyrithione, or combinations thereof. In some embodiments, the silver compound comprises silver oxide, silver ammonium adipate, silver acetate, silver pyrithione, or combinations thereof. In some embodiments, the silver compound comprises silver oxide, silver stearate, silver ammonium adipate, or combinations thereof. In some aspects, the silver is provided in the form of silver oxide. In some aspects, the silver is not provided via silver phenyl phosphinate and/or silver phenyl phosphonate.

The synthetic fiber may comprise phosphorus (in a phosphorus compound), e.g., phosphorus or a phosphorus compound. In some aspects, the phosphorus or the phosphorus compound may be dispersed in the copolymer with the one or more metal compounds or ions thereof. In one embodiment, the synthetic fiber comprises a phosphorus compound present in an amount of less than 0.03 percent by weight based on the total weight of the fiber, e.g., less than 0.025 percent by weight, less than 0.02 percent by weight, less than 0.015 percent by weight, less than 0.01 percent by weight, or less than 0.005 percent by weight. In terms of lower limits, the synthetic fiber may comprise a phosphorus compound in an amount greater than or equal to 0.001 percent by weight based on the total weight of the fiber, e.g., greater than or equal to 0.005 percent by weight, greater than or equal to 0.0075 percent by weight, or greater than or equal to 0.01 percent by weight. In terms of useful ranges, the phosphorus compound may be from 0 to 0.03 percent by weight, e.g., from 0 to 0.025 percent by weight, from 0.001 to 0.025 percent by weight, from 0.001 to 0.02 percent by weight, from 0.005 to 0.02 percent by weight.

The phosphorus optionally is present in or provided via a phosphorus compound, which may vary widely. The phosphorus compound may comprise benzene phosphinic acid, diphenylphosphinic acid, sodium phenylphosphinate, phosphorous acid, benzene phosphonic acid, calcium phenylphosphinate, potassium B-pentylphosphinate, methylphosphinic acid, manganese hypophosphite, sodium hypophosphite, monosodium phosphate, hypophosphorous acid, dimethylphosphinic acid, ethylphosphinic acid, diethylphosphinic acid, magnesium ethylphosphinate, triphenyl phosphite, dimethylphenyl phosphite, ethyldiphenyl phosphite, phenylphosphonic acid, methylphosphonic acid, ethylphosphonic acid, potassium phenylphosphonate, sodium methylphosphonate, calcium ethylphosphonate, and combinations thereof. In some embodiments, the phosphorus compound comprises phosphoric acid, benzene phosphinic acid, benzene phosphonic acid, or combinations thereof. In some embodiments, the phosphorus compound comprises benzene phosphinic acid, phosphorous acid, manganese hypophosphite, or combinations thereof. In some aspects, the phosphorus compound may comprise benzene phosphinic acid.

In one embodiment, the molar ratio of the phosphorus to the zinc ions is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the phosphorus to the zinc ions in the polymer composition may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1, from 0.5:1 to 4:1, or from 0.5:1 to 3:1. In terms of upper limits, the molar ratio of zinc ions to phosphorus in the polymer composition may be less than 15:1, e.g., less than 10:1, less than 9:1, less than 8:1, less than 7:1, less than 6:1, less than 5:1, less than 4:1, or less than 3:1. In some cases, phosphorus is dispersed within the copolymer along with zinc ions or other ions. In some cases, phosphorus is bound in the copolymer along with zinc ions or other ions.

In one embodiment, the weight ratio of zinc ions to phosphorus in the synthetic fiber may be greater than 1.3:1, e.g., greater than 1.4:1, greater than 1.5:1, greater than 1.6:1, greater than 1.7:1, greater than 1.8:1, or greater than 2:1. In terms of ranges, the weight ratio of zinc to phosphorus may range from 1.3:1 to 30:1, e.g., from 1.4:1 to 25:1, from 1.5:1 to 20:1, from 1.6:1 to 15:1, from 1.8:1 to 10:1, from 2:1 to 8:1, from 3:1 to 7:1, or from 4:1 to 6:1. In terms of upper limits, the weight ratio of zinc to phosphorus may be less than 30:1, e.g., less than 28:1, less than 26:1, less than 24:1, less than 22:1, less than 20:1, or less than 15:1. In some aspects, there is no phosphorus in the copolymer polyamide and an aromatic sulfonate or a salt thereof.

In one embodiment, the weight ratio of zinc to phosphorus in the synthetic fibers may be less than 0.64:1, e.g., less than 0.62:1, less than 0.6:1, less than 0.5:1, less than 0.45:1, less than 0.4:1, less than 0.3:1, or less than 0.25:1. In terms of ranges, the weight ratio of zinc to phosphorus in the copolymer may range from 0.001:1 to 0.64:1, e.g., from 0.01:1 to 0.6:1, from 0.05:1 to 0.5:1, from 0.1:1 to 0.45:1, from 0.2:1 to 0.4:1, from 0.25:1 to 0.35:1, or from 0.2:1 to 0.3:1. In terms of lower limits, the weight ratio of zinc to phosphorus in the copolymer may be greater than 0.001:1, e.g., greater than 0.005:1, greater than 0.01:1, greater than 0.05:1, greater than 0.1:1, greater than 0.15:1, or greater than 0.2:1.

Advantageously, it has been discovered that adding the above identified zinc compounds and phosphorus compounds may result in a beneficial relative viscosity of the copolymer. In some embodiments, the relative viscosity of the copolymer ranges from 10 to 70, e.g., from 15 to 65, from 20 to 60, from 30 to 50, from 10 to 35, or from 15 to 32. In terms of lower limits, the relative viscosity of the copolymer may be greater than or equal to 10, e.g., greater than or equal to 15, greater than or equal to 20, greater than or equal to 25, greater than or equal to 27.5, or greater than or equal to 30. In terms of upper limits, the relative viscosity of the copolymer may be less than 70, e.g., less than 65, less than 60, less than 50, less than 40, or less than 35.

It has been determined that a specific amount of the zinc compound and the phosphorus compound can be mixed in a copolymer, more particularly the polyamide composition, in finely divided form, such as in the form of granules, flakes and the like, to provide a polymer composition that can be subsequently formed, e.g., extruded, molded or otherwise drawn, into various products (e.g., high-contact products, surface layers of high-contact products) by conventional methods to produce products having substantially improved antimicrobial activity. The zinc and phosphorus are employed in the polymer composition in the aforementioned amounts to provide a fiber with improved antimicrobial activity retention (near-permanent).

### Zinc/Copper Retention Rate

As noted herein, by utilizing a copolymer with an aromatic sulfonate or a salt thereof having the aforementioned metal ion, preferably zinc ions, and/or optional phosphorus compound in an effective amount, the synthetic fiber is capable of retaining a higher percentage of metal ions, even after dyeing, without a loss of stain resistance. The resulting filament yarns and textiles are durable having near-permanent antimicrobial and/or antiviral properties. The values associated with the retention rates discussed herein are also applicable to the individual metal ions.

In some embodiments, the synthetic fibers have a metal ion retention greater than or equal to 65% as measured by a dye bath test, e.g., greater than or equal to 75%, greater than or equal to 80%, greater than or equal to 90%, greater than or equal to 95%, greater than or equal to 97%, greater than or equal to 98%, greater than or equal to 99%, greater than or equal to 99.9%, greater than or equal to 99.99%, greater than or equal to 99.999%, greater than or equal to 99.9999%, greater than or equal to 99.99999%, or greater than or equal to 99.999999%. In terms of upper limits, the synthetic fiber has a metal ion retention of less than 100%, e.g., less than 99.9%, less than 98%, or less than 95%. In terms of ranges, the synthetic fiber has a metal ion retention from 60% to 100%, e.g., from 60% to 99.999999%, from 60% to 99.99999%, from 60% to 99.9999%, from 60% to 99.999%, from 60% to 99.999%, from 60% to 99.99%, from 60% to 99.9%, from 60% to 99%, from 60% to 98%, from 60% to 95%, from 65% to 100%, from 65% to 99.999999%, from 65% to 99.99999%, from 65% to 99.9999%, from 65% to 99.999%, from 65% to 99.999%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999%, from 70% to 99.99%, from 70% to 99.9%, from 70% to 99%, from 70% to 98%, from 70% to 95%, from 75% to 100%, from 75% to 99.999999%, from 75% to 99.99999%, from 75% to 99.9999%, from 75% to 99.999%, from 75% to 99%, from 75% to 98%, from 75% to 95%, from 80% to 100%, from 80% to 99.999999%, from 80% to 99.99999%, from 80% to 99.9999%, from 80% to 99.999%, from 80% to 99.99%, from 80% to 99.9%, from 80% to 99%, from 80% to 98%, or from 80% to 95%. In some cases, the ranges and limits relate to dye recipes having lower pH values, e.g., less than (and/or including) 5.0, less than 4.7, less than 4.6, or less than 4.5. In some cases, the ranges and limits relate to dye recipes having higher pH values, e.g., greater than (and/or including) 4.0, greater than 4.2, greater than 4.5, greater than 4.7, greater than 5.0, or greater than 5.0.

In some embodiments, the synthetic fibers (or articles or products) formed from the copolymer composition having an aromatic sulfonate or salt thereof and one or more metal compounds or ions thereof has a metal ion retention greater than or equal to 40% after a dye bath, e.g., greater than or equal to 44%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 90%, greater than or equal to 95%, or greater than or equal to 99%. In terms of upper limits, the synthetic fibers may have a metal ion retention of less than 100%, e.g., less than 99.9%, less than 98%, less than 95%, or less than 90%. In terms of ranges, the antiviral fiber has a metal ion retention in a range from 40% to 100%, e.g., from 45% to 99.9%, from 50% to 99.9%, from 75% to 99.9%, from 80% to 99%, or from 90% to 98%. In some cases, the ranges and limits relate to dye recipes having higher pH values, e.g., greater than (and/or including) 4.0, greater than 4.2, greater than 4.5, greater than 4.7, greater than 5.0, or greater than 5.0.

In some embodiments, the antiviral fibers (or articles or products) formed from the copolymer having an aromatic sulfonate or a salt thereof and one or more metal compounds or ions thereof have a zinc and/or copper retention greater than or equal to 20%, e.g., greater than 24%, greater than or equal to 25%, greater than or equal to 30%, greater than or equal to 35%, greater than or equal to 40%, greater than or equal to 45%, greater than or equal to 50%, greater than or equal to 55%, or greater than or equal to 60%. In terms of upper limits, the antiviral fibers may have a zinc and/or copper retention of less than 80%, e.g., less than 77%, less than 75%, less than 70%, less than 68%, or less than 65%. In terms of ranges, the antiviral fibers may have a zinc and/or copper retention ranging from 20% to 80%, e.g., from 25% to 77%, from 30% to 75%, or from 35% to 70%. In some cases, the ranges and limits relate to dye recipes having lower pH values, e.g., less than (and/or including) 5.0, less than 4.7, less than 4.6, or less than 4.5.

In some embodiments, the synthetic fibers formed from the copolymer demonstrate an extraction rate of the metal ions less than 35% as measured by the dye bath test, e.g., less than 25%, less than 20%, less than 10%, or less than 5%. In terms of upper limits, the antiviral fiber demonstrates an extraction rate of the metal ions greater than or equal to 0%, e.g., greater than or equal to 0.1%, greater than or equal to 2%, or greater than or equal to 5%. In terms of ranges, the antiviral fiber demonstrates an extraction rate of the metal ions from 0% to 35%, e.g., from 0% to 25%, from 0% to 20%, from 0% to 10%, from 0% to 5%, from 0.1% to 35%, from 0.1% to 25%, from 0.1% to 20%, from 0.1% to 5%, from 0.2% to 10%, from 2% to 35%, from 2% to 25%, from 2% to 20%, from 2% to 10%, from 2% to 5%, from 5% to 35%, from 5% to 25%, from 5% to 20%, or from 5% to 10%.

The metal ions of a fiber (or other product) formed from the copolymer described herein may be measured by a dye bath test according to the following standard procedure. A sample is cleaned (all oils are removed) by a scour process. The scour process may employ a heated bath, e.g., conducted at 71° C. for 15 minutes. A scouring solution comprising 0.25% on weight of fiber (“owf”) of Sterox (723 Soap) nonionic surfactant and 0.25% owf of TSP (trisodium phosphate) may be used. The samples are then rinsed with cold water.

The cleaned samples may be tested according a chemical dye level procedure. This procedure may employ placing the sample in a dye bath comprising 1.0% owf of C.I. Acid Blue 45, 4.0% owf of MSP (monosodium phosphate), and a sufficient % owf of disodium phosphate or TSP to achieve a pH of 6.0, with a 28:1 liquor to fiber ratio. For example, if a pH of less than 6 is desired, a 10% solution of the desired acid may be added using an eye dropper until the desired pH was achieved. The dye bath may be preset to bring the bath to a boil at 100° C. The samples are placed in the bath for 1.5 hours. As one example, it may take approximately 30 minutes to reach boil, and the sample may be held for one hour after boiling at this temperature. Then the samples are removed from the bath and rinsed. The samples are then transferred to a centrifuge for water extraction. After water extraction, the samples are laid out to air dry. The component amounts are then recorded.

In some embodiments, the metal ion retention of a fiber formed from the copolymer may be calculated by measuring metal ions content before and after a dye bath operation. The amount of metal ions retained after the dye bath may be measured by known methods. For the dye bath, an Ahiba dyer (from Datacolor) may be employed. In a particular instance, twenty grams of un-dyed fabric and 200 ml of dye liquor may be placed in a stainless steel can, the pH may be adjusted to the desired level, the stainless steel can may be loaded into the dyer; the sample may be heated to 40° C. then heated to 100° C. (optionally at 1.5° C./minute). In some cases a temperature profile may be employed, for example, 1.5° C./minute to 60° C., 1° C./minute to 80° C., and 1.5° C./minute to 100° C. The sample may be held at 100° C. for 45 minutes, followed by cooling to 40° C. at 2° C./minute, then rinsed and dried to yield the dyed product.

In addition to the antimicrobial/antiviral (AM/AV) properties, the disclosed compositions surprisingly demonstrated improved zinc retention after washing (washfastness) of the fibers. The zinc retention may be characterized in relation to washes. The fiber and/or fabric is capable of retaining a higher percentage of zinc and/or copper, even after washing, as such the resulting yarns formed from the fibers have AM/AV properties.

In some embodiments, the synthetic fibers formed from the copolymer have a zinc and/or copper retention greater than or equal to 85% as measured after 5 washes, e.g., greater than or equal to 90%, greater than or equal to 92%, greater than or equal to 95%, greater than or equal to 96%, greater than or equal to 98%, greater than or equal to 99%, or greater than or equal to 99.9%.

In some embodiments, the synthetic fibers formed from the copolymer have a zinc and/or copper retention greater than or equal to 65% as measured after 10 washes, e.g., greater than or equal to 70%, greater than or equal to 72%, greater than or equal to 80%, greater than or equal to 85%, greater than or equal to 90%, greater than or equal to 95%, or greater than or equal to 99%.

### Fiber Dimensions and Distributions

In some cases, the synthetic fibers disclosed herein may include microfibers, e.g., fibers having an average fiber diameter of less than 50 microns, or nanofibers, e.g., fibers having an average fiber diameter of less than 1000 nm (1 micron). Combinations of microfibers and nanofibers are also envisioned for some embodiments.

In some embodiments, the synthetic fibers are microfibers suitable for carpets or fabrics. For example the microfibers may have an average fiber diameter less than 50 microns, e.g., less than 45 microns, less than 40 microns, less than 35 microns, less than 30 microns, less than 25 microns, less than 20 microns, less than 15 microns, less than 10 microns, less than 5 microns, or less than 2 microns. In terms of ranges, the average fiber diameter of the microfibers may be from 1 to 50 microns, e.g., from 1 to 45 microns, from 1 to 40 microns, from 1 to 25 microns, from 2 to 50 microns, from 2 to 45 microns, from 2 to 40 microns, or from 2 to 25 microns.

In some cases, the average fiber diameter of the microfibers may be less than 25 microns, e.g., less than 24 microns, less than 22 microns, less than 20 microns, less than 15 microns, less than 10 microns, or less than 5 microns. In terms of lower limits, the average fiber diameter of the microfibers may be at least 1 micron, at least 2 microns, at least 3 microns, at least 5 microns, at least 7 microns, or at least 10 microns. In terms of ranges, the average fiber diameter of the microfibers may be from 1 to 25 microns, e.g., from 2 to 24 microns, from 3 to 22 microns, from 5 to 20 microns, from 7 to 15 microns, from 2 to 10 microns, or from 1 to 5 microns. Such average fiber diameters differentiate the microfibers formed by the spinning methods disclosed herein from fibers formed by electrospinning methods.

In some cases, the synthetic fibers are nanofibers having an average diameter of less than 1 micron, e.g., less than 950 nanometers, less than 925 nanometers, less than 900 nanometers, less than 800 nanometers, less than 700 nanometers, less than 600 nanometers, or less than 500 nanometers. In terms of lower limits, the average fiber diameter of the nanofibers may be at least 100 nanometers, at least 110 nanometers, at least 115 nanometers, at least 120 nanometers, at least 125 nanometers, at least 130 nanometers, or at least 150 nanometers. In terms of ranges, the average fiber diameter of the nanofibers may be from 100 to 1000 nanometers, e.g., from 110 to 950 nanometers, from 115 to 925 nanometers, from 120 to 900 nanometers, from 125 to 800 nanometers, from 125 to 700 nanometers, from 130 to 600 nanometers, or from 150 to 500 nanometers. Such average fiber diameters may differentiate the nanofibers formed by the spinning methods disclosed herein from nanofibers formed by electrospinning methods. Electrospinning methods typically have average fiber diameters of less than 100 nanometers, e.g., from 50 up to less than 100 nanometers. Without being bound by theory, it is believed that such small nanofiber diameters may result in reduced strength of the fibers and increased difficulty in handling the nanofibers. However, some electrospinning methods may be contemplated.

In one embodiment, the synthetic fibers are in the form of a bulked continuous filament yarn or bulked staple yarn. In one embodiment, the synthetic fibers are formed into a product yarn having decitex per fiber (dpf) of at least 6 dpf, e.g. at least 7 dpf, at least 8 dpf, at least 9 dpf, at least 10 dpf, at least 15 dpf, or at least 20 dpf.

Having robust properties for effectively providing stain resistance and antimicrobial and/or antiviral (AM/AV) properties is useful for several applications. Thus, the polymers having both stain resistance and antimicrobial and/or antiviral (AM/AV) properties may be used as wovens, knits, or nonwovens. Such applications include interior materials such as blinds, wall papers, wall panels, and floor coverings (including rugs and carpet), medical textiles, textiles, e.g., apparel such as athletic wear or other next-to-skin apparel, and molded products.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims or the equivalents thereof.

### EXAMPLES

The present embodiments will now be described in more detail using the following examples and comparative examples. However, the present embodiments are not limited to only these examples.

Test Methods

Below are detailed descriptions of the standardized test methods used to evaluate the efficacy of test sample in regard to stain resistance. ASTM and AATCC testing protocols are considered industry standards. These protocols typically do not change significantly over time; however, if any question arises regarding the dates of these standards, unless specified herein, the standard in effect as of the filing of this application is to be used.

AATCC Test Method 175-2003 (Stain Resistance: Pile Floor Coverings). This test method is used for pile floor coverings to determine the resistance to staining by an acidic dye, i.e. acid food colors. The test method is conducted by applying a small volume of a diluted aqueous solution of Allura Red (FD&C Red 40) adjusted to an acid pH. The wetted test sample is left unperturbed for 24±4.0 hours. To remove the stain, the test sample is rinsed to remove the staining agent. Prior to evaluation, the test sample is dried at 100±5° C. for 90 minutes. The scale for evaluation is graded from 1 (severe residual stain) to 10 (no residual stain). Using this scale, a higher number indicates superior stain resistance.

ASTM D 6540 (Accelerated Soiling of Pile Yarn Floor Covering). This test method is used for pile yarn floor covering to determine soiling from an artificial soil composition. The test samples are secured to a backing sheet that is mounted inside a drum with the pile surface exposed. The exposed surface is subjected to an accelerated soiling process. The degree of soiling is measured with a device or visually using AATCC Gray scale ratings (1=severe change, 2=considerable change, 3=noticeable change, 4=slight change and 5=negligible or no change). Two measurements were made, before cleaning and after cleaning with hot water extraction.

AATCC 16 Option 3 (Colorfastness to Light; Xenon Arc Lamp). The fabrics were tested as received (no light exposure) and after 40 hours of exposure to a Xenon arc lamp. After the exposure the difference in color between the exposed and protected parts of the fabric are compared to the AATCC gray scale and the degree of fading is rated. The ratings are 1=high degree of fading, 4=slight fading and 5=no fading.

AATCC 129 (Colorfastness to Atmospheric Contaminants O₃) This test method is used for determining the resistance of the color of textiles to the action of ozone in the atmosphere at elevated temperatures with relative humidities above 85%. A test specimen and a swatch of control sample are simultaneously exposed to ozone in an atmosphere which is maintained at 87.5±2.5% relative humidity and a temperature of 40±1° C. (104±2° F.) until the control sample shows a color change corresponding to that of a standard of fading. The cycles are repeated until the specimen shows a definite color change or for a prescribed number of cycles. On certain fibers, dye fading does not readily take place at humidities below 85%. Testing at high humidities is required to produce color change that predicts service fading under warm, humid conditions.

AATCC 23 (Colorfastness to Atmospheric Contaminants NOₓ) This test method is intended for assessing the resistance of the color of textiles of all kinds and in all forms when exposed to atmospheric oxides of nitrogen as derived from the combustion of natural gas. A specimen of the textile and the test control fabric are exposed simultaneously to oxides of nitrogen from burnt gas fumes until the control shows a change in color corresponding to that of the standard of fading. The change in the color of the specimen is assessed with the standard gray scale for assessing change in color.

ASTM D-5252 (Hexapod Tumble Drum Tester) This test describes the equipment and operation of the hexapod tumble drum tester for testing pile floor covering to produce changes in appearance and color due to changes in surface structure by mechanical action tester. The scope of testing involves securing a test sample along the inside diameter of a rotating drum apparatus. As the drum rotates, a metal ball covered with polyurethane studs tumbles around inside the drum to simulate traffic or wear. The test sample is checked and rated based the change of appearance and color in the surface. Appearance Retention Rating (ARR) is determined by grading the appearance change of carpet subjected to exposure conditions in accordance with the ASTM D-5252 (Hexapod).

AATCC-171 (Hot Water Extraction Method) This test method provides a laboratory procedure to clean textile floor coverings by a technique simulating cleaning of installed floor coverings by hot water extraction, sometimes erroneously called “steam cleaning.” The test is performed by securing a specimen of carpet, face up, on a floor or a mounting board. An extraction cleaning head is passed over each section of the specimen. Each cleaning uses two passes with a wand, against the pile, first with solution and vacuum, and the second with vacuum only. The solution temperature is 60±2° C. (140±5° F.) with a pH of about 9.0. The solution comprises linear alcohol ethoxylate (3.0-4.5 g/l)+sodium tri-polyphosphate. The pile is erected with a brush or pile rake and the specimen is dried at room temperature.

### Examples 1-5 Preparation

The following test samples were prepared from a 3500 ppm sulfonated, 350 ppm zinc containing polyamide 6,6 and solution dyed into color “Golden Sand”. Resulting drawn/textured yarns were 1200 denier/132 filament (˜9 dpf), cabled at 4.8 twists per inch in the “S” direction, Superba heatset and tufted into a 45 oz/yd², 1/10 gauge cut pile with 17/32″ pile height and 32 stitches per 3 inches. The samples were then coated and dry cured using a topical combination of non-fluorinated soil release/stainblocker with Example 1 biased toward stainblocker, Example 2 biased toward soil release and Example 3 serving as control, i.e. having no stainblocker or soil release.

Examples 4 and 5 were prepared from a 3500 ppm sulfonated, 350 ppm zinc containing polyamide 6,6 and solution dyed into colors “Tuxedo” and “Dark Grey”. Resulting drawn/textured yarns were 1200 denier/60 filament (20 dpf) and were subsequently cabled together to create two barberpole yarns one being 3.5 twists per inch in the “S” direction non heatset and the other being similarly barberpoled at 5.0 twists per inch in the “S” direction and Superba heatset. The 3.5 twist per inch yarn was tufted into a 23.5 oz/yd², 1/10 gauge textured loop at 4/32″ and 8/32″ pile heights and 42 stitches per 3 inches. The 5.0 twist per inch substrate is a 30 oz/yd², patterned ⅛ gauge LCL (Loop/Cut Loop) at 17/32″ pile height and 42 stitches per 3 inches. Both resulting samples were coated and dry cured using the biased toward stainblocker condition cited above.

Table 1 reports the results of the testing and each example had improved stain resistance and soil release.

TABLE 1

| | | ASTM D 6540 | |
|---|---|---|---|
| | | Before | After |
| | AATCC 175 | Cleaning | Cleaning |
| Example 1 | 9 | 2-3 | 4-5 |
| Example 2 | 7 | 2 | 4 |
| Example 3 | 6 | 2-3 | 3-4 |
| Example 4 | 10 | 4 | 4-5 |
| Example 5 | 10 | 4 | 4-5 |

Examples 4 and 5 were also tested for other properties which are reported in Table 2.

TABLE 2

| | Example 4 | Example 5 |
|---|---|---|
| AATCC 16.3 | 5 | 5 |
| AATCC 129 | 5 | 5 |
| AATCC 23 | 5 | 5 |
| ASTM D-5252 | 3-5 | — |

Examples 1-3 were also tested for antimicrobial properties against a cotton control. The results were measured after 24 hours. The log reduction is reported in Table 3 and indicates superior antimicrobial properties for Examples 1-3.

TABLE 3
Antimicrobial Properties

| | | Staphylococcus | Klebsiella | Escherichia |
|---|---|---|---|---|
| | Zinc | aureus | pneumoniae | coli |
| | [ppm] | (ISO20743) | (ISO20743) | (ASTM E3160) |
| Example 1 | 913 | 8.37 | 8.53 | 7.48 |
| Example 2 | 933 | 8.37 | 8.53 | 7.48 |
| Example 3 | 943 | 8.37 | 6.15 | 7.48 |

Examples 4 and 5 were also tested for antimicrobial properties against a cotton control and nylon control. The results were measured after 24 hours. The log reduction is reported in Table 4 and indicates superior biocidal and inhibitory properties for Examples 4 and 5.

TABLE 4
Antimicrobial Properties

| | | vs. Cotton Control | | vs. Nylon Control | |
|---|---|---|---|---|---|
| | | Staphylococcus | Klebsiella | Staphylococcus | Klebsiella |
| | Zinc | aureus | pneumoniae | aureus | pneumoniae |
| | [ppm] | (ISO20743) | (ISO20743) | (ISO20743) | (ISO20743) |
| Example 4 | 336 | 2.35 | 2.39 | 2.46 | 2.24 |
| Example 5 | 351 | 2.54 | 3.75 | 3.11 | 3.21 |

To test the retention of zinc after cleaning, Example 4 was repeatedly cleaned according to AATCC 171. Two different initial loadings of zinc were tested for Example 4: 350 ppm zinc and 904 ppm. After 10 and 12 cycles of cleaning, Example 4 showed excellent retention of zinc as shown in Table 5.

TABLE 5
Example 4

| Cycles | | | | | | | | | | | |
|---|---|---|---|---|---|---|---|---|---|---|---|
| 1 | 2 | 3 | 4 | 5 | 6 | 7 | 8 | 9 | 10 | 11 | 12 |

350 ppm of zinc

| | | | | | | | | | | | | |
|---|---|---|---|---|---|---|---|---|---|---|---|---|
| 350 | 333 | 332 | 327 | 327 | 309 | 327 | 320 | 319 | 323 | 318 | 299 | 306 |

904 ppm of zinc

| | | | | | | | | | | | | |
|---|---|---|---|---|---|---|---|---|---|---|---|---|
| 904 | 904 | 879 | 887 | 895 | 867 | 769 | 801 | 841 | 773 | 807 | — | — |

### Residential and Commercial Carpets—Examples 6-13

Test samples of residential and commercial carpets were tested prior to tufting. The residential carpets, Examples 6 and 7 were sulfonated polyamide 6,6 having 9 dpf. The commercial carpets, Examples 8-13, were also sulfonated having a 16 or 20 dpf. Examples 12 and 13 had a 20 dpf, while Examples 8-11 had a 16 dpf. The zinc amounts are shown in Table 6 along with the antimicrobial properties against a cotton control and nylon control. The test was ISO20743 after 24 hours. The residential carpets showed improved biocidal performance, while the commercial carpets had excellent biocidal performance resulting in complete kill.

TABLE 6
Antimicrobial Properties

| | | vs. Cotton Control | | vs. Nylon Control | |
|---|---|---|---|---|---|
| | | Staphylococcus | Klebsiella | Staphylococcus | Klebsiella |
| | Zinc | aureus | pneumoniae | aureus | pneumoniae |
| | [ppm] | (ISO20743) | (ISO20743) | (ISO20743) | (ISO20743) |
| Example 6 | 421 | 3.6 | 4.51 | 3.68 | 3.66 |
| Example 7 | 472 | 3.37 | 4.41 | 3.45 | 3.31 |
| Example 8 | 371 | 7.63 | 8.3 | 7.69 | 7.74 |
| Example 9 | 362 | 7.83 | 8.63 | 7.91 | 7.79 |
| Example 10 | 382 | 7.63 | 8.28 | 7.67 | 7.74 |
| Example 11 | 352 | 7.26 | 7.21 | 9.27 | 7.55 |
| Example 12 | 297 | 7.37 | 7.21 | 9.01 | 7.33 |
| Example 13 | 348 | 7.07 | 7.21 | 9.01 | 7.33 |

### EMBODIMENTS

As used below, any reference to a series of embodiments is to be understood as a reference to each of those embodiments disjunctively (e.g., “Embodiments 1-4” is to be understood as “Embodiments 1, 2, 3, or 4”).

Embodiment 1 is a copolymer comprising a polyamide polymer present in a range from 85 to 99.5 percent by weight based on the total weight of the copolymer; an aromatic sulfonate or a salt thereof present in a range from 0.5 to 10 percent by weight based on the total weight of the copolymer, one or more metal compounds or ions thereof dispersed within the polyamide; and a phosphorus compound present in a range of less than 0.03 percent by weight based on the total weight of the copolymer.

Embodiment 2 is the copolymer of Embodiment 1, wherein the aromatic sulfonate salt is a lithium, sodium, or potassium salt of 5-sulfoisophthalic acid.

Embodiment 3 is the copolymer of any one of Embodiments 1 or 2, wherein the aromatic sulfonate salt is a zinc salt of an aromatic sulfonate.

Embodiment 4 is the copolymer of any one of Embodiments 1-3, wherein the aromatic sulfonate comprises isophthalic acid sulfonate, terephthalic acid sulfonate, 2,6-naphthalene dicarboxylic acid sulfonate, 3,4′-diphenyl ether dicarboxylic acid sulfonate, hexahydrophthalic acid sulfonate, 2,7-naphthalenedicarboxylic acid sulfonate, phthalic acid sulfonate, 4,4′-methylenebis(benzoic acid) sulfonate, or salts thereof.

Embodiment 5 is the copolymer of any one of Embodiments 1-4, wherein the aromatic sulfonate is dimethyl-5-sulfoisophthalate.

Embodiment 6 is the copolymer of any one of Embodiments 1-5, wherein the polyamide is the reaction product of one or more diacids, wherein more than 80% of the diacids are aliphatic diacid monomers and one or more diamines, wherein more than 80% of the diamines are aliphatic diamine monomers.

Embodiment 7 is the copolymer of any one of Embodiments 1-6, wherein the polyamide is polyamide 6,6.

Embodiment 8 is the copolymer of any one of Embodiments 1-7, wherein the polyamide has a relative viscosity in the range from 10 to 70.

Embodiment 9 is the copolymer of any one of Embodiments 1-8, wherein the polyamide has an amine end group content of less than or equal to 55 μeq/gram.

Embodiment 10 is the copolymer of any one of Embodiments 1-9, wherein the one or more metal compounds or ions thereof comprise zinc, copper, or silver.

Embodiment 11 is the copolymer of any one of Embodiments 1-10, wherein the one or more metal compounds are present an amount that is greater than or equal to 200 ppm by weight, based on the total weight of the copolymer.

Embodiment 12 is the copolymer of any one of Embodiments 1-11, wherein the one or more metal compounds or ions are present in an amount from 200 ppm to 1,000 ppm by weight, based on the total weight of the copolymer.

Embodiment 13 is the copolymer of any one of Embodiments 1-12, wherein the one or more metal compounds comprise oxides, stearates, adipates, acetates, pyrithiones, or combinations thereof.

Embodiment 14 is a copolymer comprising a polyamide present in a range from 85 to 99.5 percent by weight based on the total weight of the copolymer; a zinc salt of aromatic sulfonate present in a range from 0.5 to 10 percent by weight based on the total weight of the copolymer; and a phosphorus compound present in a range of less than 0.03 percent by weight based on the total weight of the copolymer.

Embodiment 15 is the copolymer of Embodiment 14, wherein the aromatic sulfonate comprises isophthalic acid sulfonate, terephthalic acid sulfonate, 2,6-naphthalene dicarboxylic acid sulfonate, 3,4′-diphenyl ether dicarboxylic acid sulfonate, hexahydrophthalic acid sulfonate, 2,7-naphthalenedicarboxylic acid sulfonate, phthalic acid sulfonate, 4,4′-methylenebis(benzoic acid) sulfonate, or salts thereof.

Embodiment 16 is the copolymer of any one of Embodiments 14 or 15, wherein the aromatic sulfonate is dimethyl-5-sulfoisophthalate.

Embodiment 17 is the copolymer of any one of Embodiments 14-16, wherein the polyamide is the reaction product of one or more diacids, wherein more than 80% of the diacids are aliphatic diacid monomers and one or more diamines, wherein more than 80% of the diamines are aliphatic diamine monomers.

Embodiment 18 is the copolymer of any one of Embodiments 14-17, wherein the polyamide is polyamide 6,6.

Embodiment 19 is the copolymer of any one of Embodiments 14-18, wherein the polyamide has a relative viscosity in the range from 10 to 70.

Embodiment 20 is the copolymer of any one of Embodiments 14-19, wherein the polyamide has an amine end group content of less than or equal to 55 μeq/gram.

Embodiment 21 is the copolymer of any one of Embodiments 14-20, wherein the zinc salt of aromatic sulfonate provides more than 75% of the zinc to the copolymer.

Embodiment 22 is a synthetic fiber comprising: a copolymer comprising from 85 to 99.5 percent by weight of a polyamide based on the total weight of the fiber and an aromatic sulfonate or a salt thereof present in a range from 0.5 to 10 percent by weight based on the total weight of the fiber, one or more metal compounds or ions thereof dispersed within the copolymer; and a phosphorus compound present in an amount of less than 0.03 percent by weight based on the total weight of the fiber; wherein fibers exhibit a) a Staphylococcus aureus log reduction greater than 2.0 as tested in accordance with ISO 20743-13 and b) an Klebsiella pneumonia log reduction greater than 2.0 as tested in accordance with ISO 20743-13.

Embodiment 23 is the synthetic fiber of Embodiment 22, wherein the aromatic sulfonate salt is a lithium, sodium, or potassium salt of 5-sulfoisophthalic acid.

Embodiment 24 is the synthetic fiber of any one of Embodiments 22 or 23, wherein the aromatic sulfonate salt is a zinc salt of an aromatic sulfonate.

Embodiment 25 is the synthetic fiber of any one of Embodiments 22-24, wherein the aromatic sulfonate comprises isophthalic acid sulfonate, terephthalic acid sulfonate, 2,6-naphthalene dicarboxylic acid sulfonate, 3,4′-diphenyl ether dicarboxylic acid sulfonate, hexahydrophthalic acid sulfonate, 2,7-naphthalenedicarboxylic acid sulfonate, phthalic acid sulfonate, 4,4′-methylenebis(benzoic acid) sulfonate, or salts thereof.

Embodiment 26 is the synthetic fiber of any one of Embodiments 22-25, wherein the aromatic sulfonate is dimethyl-5-sulfoisophthalate.

Embodiment 27 is the synthetic fiber of any one of Embodiments 22-26, wherein fiber comprises stabilizers, delusterants, antioxidants, solubilizers, agents which counteract fragrances or odors, complexing agents, compatibilizing agent, colorants, promoters enhancing oxygen barrier properties, or combinations thereof.

Embodiment 28 is the synthetic fiber of any one of Embodiments 22-27, wherein the polyamide is the reaction product of one or more diacids, wherein more than 80% of the diacids are aliphatic diacid monomers, and one or more diamines, wherein more than 80% of the diamines are aliphatic diamine monomers.

Embodiment 29 is the synthetic fiber of any one of Embodiments 22-28, wherein the polyamide is polyamide 6,6.

Embodiment 30 is the synthetic fiber of any one of Embodiments 22-29, wherein the polyamide has a relative viscosity in the range from 10 to 70.

Embodiment 31 is the synthetic fiber of any one of Embodiments 22-30, wherein the polyamide has an amine end group content of less than or equal to 55 μeq/gram.

Embodiment 32 is the synthetic fiber of any one of Embodiments 22-31, wherein the one or more metal compounds or ions thereof comprise zinc, copper, or silver.

Embodiment 33 is the synthetic fiber of any one of Embodiments 22-32, wherein the one or more metal compounds are present an amount that is greater than or equal to 200 ppm by weight, based on the total weight of the fiber.

Embodiment 34 is the synthetic fiber of any one of Embodiments 22-33, wherein the one or more metal compounds or ions are present in an amount from 200 ppm to 1,000 ppm by weight, based on the total weight of the fiber.

Embodiment 35 is the synthetic fiber of any one of Embodiments 22-34, wherein the one or more metal compounds comprise oxides, stearates, adipates, acetates, pyrithiones, or combinations thereof.

Embodiment 36 is the synthetic fiber of any one of Embodiments 22-35, wherein the synthetic fibers have an average fiber diameter of less than 50 microns.

Embodiment 37 is the synthetic fiber of any one of Embodiments 22-36, wherein the synthetic fibers are in the form of a bulked continuous filament yarn.

Embodiment 38 is the synthetic fiber of any one of Embodiments 22-37, wherein the synthetic fibers are in the form of a bulked staple yarn.

Embodiment 39 is a carpet fabricated from the synthetic fiber of any one of Embodiments 22-38.

Embodiment 40 is a synthetic fiber comprising: a polyester polymer or polyolefin polymer having a stain resistance that is greater than a polyamide without an aromatic sulfonate or salt thereof one or more metal compounds or ions thereof dispersed within the polyester or polyolefin polymer; and a phosphorus compound present in an amount of less than 0.03 percent by weight based on the total weight of the fiber; wherein fibers exhibit a) a Staphylococcus aureus log reduction greater than 2.0 as tested in accordance with ISO 20743-13 and b) an Klebsiella pneumonia log reduction greater than 2.0 as tested in accordance with ISO 20743-13.

Embodiment 41 is a synthetic fiber of Embodiment 40, wherein the polyester or polyolefin polymer contains less than 0.01 wt. % of an aromatic sulfonate or salt thereof.

Embodiment 42 is a synthetic fiber of any one of Embodiments 40 or 41, wherein fiber comprises stabilizers, delusterants, antioxidants, solubilizers, agents which counteract fragrances or odors, complexing agents, compatibilizing agent, colorants, promoters enhancing oxygen barrier properties, or combinations thereof.

Embodiment 43 is a synthetic fiber of any one of Embodiments 40-42, wherein the polyester polymer comprises polytrimethylene terephthalate, polyethylene terephthalate, or combinations thereof.

Embodiment 44 is a synthetic fiber of any one of Embodiments 40-43, wherein the polyolefin polymer comprises polypropylene.

Embodiment 45 is a synthetic fiber of any one of Embodiments 40-44, wherein the one or more metal compounds are present an amount that is greater than or equal to 200 ppm by weight, based on the total weight of the fiber.

Embodiment 46 is a synthetic fiber of any one of Embodiments 40-45, wherein the one or more metal compounds or ions are present in an amount from 200 ppm to 1,000 ppm by weight, based on the total weight of the fiber.

Embodiment 47 is a synthetic fiber of any one of Embodiments 40-46, wherein the one or more metal compounds comprise oxides, stearates, adipates, acetates, pyrithiones, or combinations thereof.

Embodiment 48 is a synthetic fiber of any one of Embodiments 40-47, wherein the synthetic fibers have an average fiber diameter of less than 50 microns.

Embodiment 49 is a synthetic fiber of any one of Embodiments 40-48, wherein the synthetic fibers are in the form of a bulked continuous filament yarn.

Embodiment 50 is a synthetic fiber of any one of Embodiments 40-49, wherein the synthetic fibers are in the form of a bulked staple yarn.

Embodiment 51 is a carpet fabricated from the synthetic fiber of any one of Embodiments 40-50.

While the disclosure has been described in detail, modifications within the spirit and scope of the disclosure will be readily apparent to those of skill in the art. Such modifications are also to be considered as part of the present disclosure. In view of the foregoing discussion, relevant knowledge in the art and references discussed above in connection with the Background, the disclosures of which are all incorporated herein by reference, further description is deemed unnecessary. In addition, it should be understood from the foregoing discussion that aspects of the disclosure and portions of various embodiments may be combined or interchanged either in whole or in part. Furthermore, those of ordinary skill in the art will appreciate that the foregoing description is by way of example only, and is not intended to limit the disclosure. Finally, all patents, publications, and applications referenced herein are incorporated by reference in their entireties.

We claim:

1. A copolymer comprising
a polyamide polymer present in a range from 85 to 99.5 percent by weight based on the total weight of the copolymer;
an aromatic sulfonate or a salt thereof present in a range from 0.5 to 10 percent by weight based on the total weight of the copolymer,
one or more metal compounds or ions thereof dispersed within the polyamide; and
a phosphorus compound present in a range of less than 0.03 percent by weight based on the total weight of the copolymer.

2. The copolymer of claim 1, wherein the aromatic sulfonate salt is a lithium, sodium, or potassium salt of 5-sulfoisophthalic acid.

3. The copolymer of claim 1, wherein the aromatic sulfonate comprises isophthalic acid sulfonate, terephthalic acid sulfonate, 2,6-naphthalene dicarboxylic acid sulfonate, 3,4′-diphenyl ether dicarboxylic acid sulfonate, hexahydrophthalic acid sulfonate, 2,7-naphthalenedicarboxylic acid sulfonate, phthalic acid sulfonate, 4,4′-methylenebis(benzoic acid) sulfonate, or salts thereof.

4. The copolymer of claim 1, wherein the polyamide is the reaction product of one or more diacids, wherein more than 80% of the diacids are aliphatic diacid monomers, and one or more diamines, wherein more than 80% of the diamines are aliphatic diamine monomers.

5. The copolymer of claim 1, wherein the one or more metal compounds or ions thereof comprise zinc, copper, or silver.

6. The copolymer of claim 1, wherein the one or more metal compounds are present an amount that is greater than or equal to 200 ppm by weight, based on the total weight of the copolymer.

7. The copolymer of claim 1, wherein the one or more metal compounds comprise oxides, stearates, adipates, acetates, pyrithiones, or combinations thereof.

8. A copolymer comprising
a polyamide present in a range from 85 to 99.5 percent by weight based on the total weight of the copolymer;
a zinc salt of aromatic sulfonate present in a range from 0.5 to 10 percent by weight based on the total weight of the copolymer; and
a phosphorus compound present in a range of less than 0.03 percent by weight based on the total weight of the copolymer.

9. The copolymer of claim 8, wherein the aromatic sulfonate comprises isophthalic acid sulfonate, terephthalic acid sulfonate, 2,6-naphthalene dicarboxylic acid sulfonate, 3,4′-diphenyl ether dicarboxylic acid sulfonate, hexahydrophthalic acid sulfonate, 2,7-naphthalenedicarboxylic acid sulfonate, phthalic acid sulfonate, 4,4′-methylenebis(benzoic acid) sulfonate, or salts thereof.

10. The copolymer of claim 8, wherein the polyamide is the reaction product of one or more diacids, wherein more than 80% of the diacids are aliphatic diacid monomers, and one or more diamines, wherein more than 80% of the diamines are aliphatic diamine monomers.

11. The copolymer of claim 8, wherein the zinc salt of aromatic sulfonate provides more than 75% of the zinc to the copolymer.

12. A synthetic fiber comprising:
a copolymer comprising from 85 to 99.5 percent by weight of a polyamide based on the total weight of the fiber and an aromatic sulfonate or salt thereof present in a range from 0.5 to 10 percent by weight based on the total weight of the fiber;
one or more metal compounds or ions thereof dispersed within the copolymer; and
a phosphorus compound present in an amount of less than 0.03 percent by weight based on the total weight of the fiber;
wherein fibers exhibit a) a Staphylococcus aureus log reduction greater than 2.0 as tested in accordance with ISO 20743-13 and b) an Klebsiella pneumonia log reduction greater than 2.0 as tested in accordance with ISO 20743-13.

13. The synthetic fiber of claim 12, wherein the aromatic sulfonate salt is a lithium, sodium, or potassium salt of 5-sulfoisophthalic acid.

14. The synthetic fiber of claim 12, wherein the aromatic sulfonate comprises isophthalic acid sulfonate, terephthalic acid sulfonate, 2,6-naphthalene dicarboxylic acid sulfonate, 3,4′-diphenyl ether dicarboxylic acid sulfonate, hexahydrophthalic acid sulfonate, 2,7-naphthalenedicarboxylic acid sulfonate, phthalic acid sulfonate, 4,4′-methylenebis(benzoic acid) sulfonate, or salts thereof.

15. The synthetic fiber of claim 12, wherein fiber comprises stabilizers, delusterants, antioxidants, solubilizers, agents which counteract fragrances or odors, complexing agents, compatibilizing agent, colorants, promoters enhancing oxygen barrier properties, or combinations thereof.

16. The synthetic fiber of claim 12, wherein the polyamide is the reaction product of one or more diacids, wherein more than 80% of the diacids are aliphatic diacid monomers, and one or more diamines, wherein more than 80% of the diamines are aliphatic diamine monomers.

17. The synthetic fiber of claim 12, wherein the one or more metal compounds or ions thereof comprise zinc, copper, or silver.

18. The synthetic fiber of claim 12, wherein the one or more metal compounds are present an amount that is greater than or equal to 200 ppm by weight, based on the total weight of the fiber.

19. The synthetic fiber of claim 12, wherein the one or more metal compounds comprise oxides, stearates, adipates, acetates, pyrithiones, or combinations thereof.

20. A carpet fabricated from the synthetic fiber of claim 12.
